(19) United States
(12) Patent Application Publication
(10) Pub. No.: US 2023/0331122 A1
(43) Pub. Date: Oct. 19, 2023

(54) FUEL CELL ELECTRIC VEHICLE

(71) Applicants: HYUNDAI MOTOR COMPANY, SEOUL (KR); KIA CORPORATION, SEOUL (KR)

(72) Inventors: Kyung Seok Park, Yongin-si (KR); Tae Soo Chi, Suwon-si (KR); Jong Woo Nam, Seoul (KR)

(21) Appl. No.: 17/939,258

(22) Filed: Sep. 7, 2022

(30) Foreign Application Priority Data
Apr. 19, 2022 (KR) 10-2022-0048373

(51) Int. Cl. B60L 58/32; H01M 8/04029; H01M 8/04007; H01M 8/04746; B60L 50/70; B60K 1/00

(52) U.S. Cl. CPC B60L 58/32; H01M 8/04029; H01M 8/04074; H01M 8/04768; B60L 50/70; B60K 1/00; H01M 2250/20; B60K 2001/003

(57) ABSTRACT

A fuel cell electric vehicle includes a cabin, a front compartment disposed below the cabin, a wind deflector disposed above the cabin, and a stack thermal management system including first and second stack radiators thermally connected to a fuel cell stack. The first stack radiator may be disposed in the front compartment, and the second stack radiator may be disposed in the wind deflector.

### CROSS REFERENCE TO RELATED APPLICATIONS

This application claims priority to and the benefit of Korean Patent Application No. 10-2022-0048373 filed in the Korean Intellectual Property Office on Apr. 19, 2022, the entire contents of which are incorporated herein by reference.

### TECHNICAL FIELD

The present disclosure relates to a fuel cell electric vehicle, and more particularly, to a fuel cell electric vehicle capable of improving performance in cooling a fuel cell stack and aerodynamic performance.

### BACKGROUND

A fuel cell electric vehicle includes a fuel cell stack configured to generate electricity using an electrochemical reaction between hydrogen and oxygen, and a stack thermal management system configured to maintain a temperature of the fuel cell stack in an appropriate operating temperature range. The stack thermal management system includes a stack radiator thermally connected to the fuel cell stack, and a pump configured to circulate a coolant to a stack radiator and a coolant passageway of the fuel cell stack.

The fuel cell electric vehicle has a front compartment. A power electronic (PE) system including an electric motor, a speed reducer, an inverter, and the like is disposed in the front compartment. The fuel cell electric vehicle includes a grille provided at a front end of the fuel cell electric vehicle. The grille has a plurality of through-holes that allow outside air to flow to the front compartment. Meanwhile, an opening area of the grille of the fuel cell electric vehicle may be relatively small. For this reason, it may be difficult to ensure a sufficient flow rate of outside air introduced into the front compartment.

Further, the stack radiator, a condenser of an HVAC system, and the radiator of the PE system are disposed in the front compartment of the fuel cell electric vehicle in order to exchange heat with the outside air introduced through the grille. A cooling fan is positioned rearward of the stack radiator. The cooling fan is configured to forcibly blow the outside air toward the stack radiator, the condenser of the HVAC system, and the radiator of the PE system.

However, in the case of the fuel cell electric vehicle in the related art, the flow rate of the outside air introduced through the grille is limited even though a position of the stack radiator is changed in the front compartment or a capacity of the stack radiator is increased. For this reason, there is a problem in that it is difficult to implement satisfactory performance in cooling the fuel cell stack.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a fuel cell electric vehicle, in which a stack radiator is additionally provided in a wind deflector disposed above a cabin, which makes it possible to improve performance in cooling a fuel cell stack and improve aerodynamic performance of a vehicle in accordance with a driving condition of the vehicle.

An embodiment of the present disclosure provides a fuel cell electric vehicle including a cabin, a front compartment disposed below the cabin, a wind deflector disposed above the cabin, and a stack thermal management system including first and second stack radiators thermally connected to a fuel cell stack. Therefore, the first stack radiator and the second stack radiator may be selectively used in accordance with a driving condition of a vehicle, which makes it possible to improve the performance in cooling the fuel cell stack and prevent deterioration in aerodynamic performance in accordance with the driving condition of the vehicle.

The first stack radiator may be disposed in the front compartment.

The fuel cell electric vehicle according to the embodiment of the present disclosure may further include an upper partition wall configured to block a gap between the first stack radiator and a cabin floor of the cabin; and a movable member movably disposed below the first stack radiator. As described above, with the upper partition wall and the movable member, the first stack radiator may adjust a flow rate of outside air passing through the first stack radiator.

The movable member may be configured to move between a covered position at which the movable member covers a gap between a ground surface and a lower end of the first stack radiator and an uncovered position at which the movable member uncovers the gap between the ground surface and the lower end of the first stack radiator. When the movable member is positioned at the covered position, the flow rate of the outside air passing through the first stack radiator may relatively increase. When the movable member is positioned at the uncovered position, the flow rate of the outside air passing through the first stack radiator may relatively decrease. However, the aerodynamic performance of the fuel cell electric vehicle may be relatively improved.

The wind deflector may include an opening, and a flap configured to cover or uncover the opening. Since the flap covers or uncovers the opening as described above, it is possible to adjust the flow rate of the outside air passing through the second stack radiator disposed in the wind deflector.

A front end of the wind deflector may be positioned forward of an upper end of a windshield glass of the cabin. Since the front end of the wind deflector is positioned forward of the upper end of the windshield glass as described above, the aerodynamic performance of the fuel cell electric vehicle may be sufficiently ensured.

The second stack radiator may be disposed in the wind deflector.

The second stack radiator may be disposed to be inclined in the wind deflector. Therefore, a mounting space for the second stack radiator may be sufficiently ensured, and thus a capacity (size) of the second stack radiator may be larger than a capacity (size) of the first stack radiator.

The first stack radiator may be thermally connected to the fuel cell stack through a coolant loop, and the second stack radiator may be connected in parallel to the first stack radiator through a distribution conduit. Therefore, the distribution conduit may allow at least a portion of the coolant exiting the fuel cell stack to flow to the second stack radiator.

The distribution conduit may be configured to connect an upstream point of the fuel cell stack and a downstream point of the fuel cell stack.

The stack thermal management system may further include a first switching valve provided at a connection portion between the distribution conduit and the coolant loop. The first switching valve may be configured to adjust a flow of a coolant between the coolant loop and the distribution conduit.

The first switching valve may be configured to adjust a flow of the coolant between the second stack radiator, the first stack radiator, and an outlet of the fuel cell stack.

The first switching valve may be configured to block or allow a flow of the coolant to the distribution conduit and block or allow a flow of the coolant to the first stack radiator.

The stack thermal management system may further include a connection conduit configured to connect the coolant loop and the distribution conduit.

The connection conduit may be configured to allow the coolant exiting the first stack radiator to flow to the second stack radiator.

The stack thermal management system may further include a second switching valve provided at a connection portion between the connection conduit and the coolant loop. The second switching valve may be configured to adjust a flow of the coolant between the coolant loop and the connection conduit.

The second switching valve may be configured to adjust a flow of the coolant between the first stack radiator and the connection conduit.

The second switching valve may be configured to block or allow a flow of the coolant to the connection conduit. The fuel cell electric vehicle according to the embodiment of the present disclosure may further include a coolant loop configured to connect the fuel cell stack and the first stack radiator, a distribution conduit configured to connect the second stack radiator and the coolant loop, a connection conduit configured to connect the coolant loop and the distribution conduit, a first switching valve configured to adjust a flow of a coolant between the coolant loop and the distribution conduit, a second switching valve configured to adjust a flow of the coolant between the coolant loop and the connection conduit; and a controller configured to control an operation of the first switching valve and an operation of the second switching valve in accordance with a driving condition and a load condition of the fuel cell stack.

When the fuel cell stack operates in a low-load condition in which a cooling load of the fuel cell stack is equal to or lower than a preset load and the fuel cell electric vehicle travels in a low-speed driving condition in which a speed of the fuel cell electric vehicle is equal to or lower than a preset speed, the controller may control the first switching valve to block a flow of the coolant to the distribution conduit and allow a flow of the coolant to the first stack radiator, and the controller may control the second switching valve to block a flow of the coolant to the connection conduit.

When the fuel cell stack operates in a low-load condition in which a cooling load of the fuel cell stack is equal to or lower than a preset load and the fuel cell electric vehicle travels in a high-speed driving condition in which a speed of the fuel cell electric vehicle is higher than a preset speed, the controller may control the first switching valve to allow a flow of the coolant to the distribution conduit and block a flow of the coolant to the first stack radiator, and the controller may control the second switching valve to block a flow of the coolant to the connection conduit.

When the fuel cell stack operates in a high-load condition in which a cooling load of the fuel cell stack is higher than a preset load and the fuel cell electric vehicle travels in a low-speed driving condition in which a speed of the fuel cell electric vehicle is equal to or lower than a preset speed, the controller may control the first switching valve to block a flow of the coolant to the distribution conduit and allow a flow of the coolant to the first stack radiator, and the controller may control the second switching valve to allow a flow of the coolant to the connection conduit.

When the fuel cell stack operates in a high-load condition in which a cooling load of the fuel cell stack is higher than a preset load and the fuel cell electric vehicle travels in a high-speed driving condition in which a speed of the fuel cell electric vehicle is higher than a preset speed, the controller may control the first switching valve to allow a flow of the coolant to the distribution conduit and a flow of the coolant to the first stack radiator, and the controller may control the second switching valve to block a flow of the coolant to the connection conduit.

In the fuel cell electric vehicle according to the present disclosure, it is possible to appropriately control the coolant to selectively pass through the first stack radiator and the second stack radiator in accordance with the driving condition of the fuel cell electric vehicle. Therefore, it is possible to optimize the performance in cooling the fuel cell stack and the aerodynamic performance of the fuel cell electric vehicle in accordance with the driving condition of the fuel cell electric vehicle.

### BRIEF DESCRIPTION OF THE FIGURES

FIG. 1 is a view illustrating a front portion of a fuel cell electric vehicle according to an embodiment of the present disclosure and illustrating a state in which a movable member is positioned at a covered position and a lower flap and an upper flap are positioned at covered positions.

FIG. 2 is a view illustrating a state in which a coolant is cooled only by a first stack radiator in a stack thermal management system of the fuel cell electric vehicle according to the embodiment of the present disclosure.

FIG. 3 is a view illustrating the front portion of the fuel cell electric vehicle according to the embodiment of the present disclosure and illustrating a state in which the movable member is positioned at the uncovered position and the lower flap and the upper flap are positioned at the uncovered positions.

FIG. 4 is a view illustrating a state in which the coolant is cooled only by a second stack radiator in the stack thermal management system of the fuel cell electric vehicle according to the embodiment of the present disclosure.

FIG. 5 is a view illustrating the front portion of the fuel cell electric vehicle according to the embodiment of the present disclosure and illustrating a state in which the movable member is positioned at the covered position and the lower flap and the upper flap are positioned at the uncovered positions.

FIG. 6 is a view illustrating a state in which the first stack radiator is connected in series to the second stack radiator and the coolant is cooled by the first stack radiator and the second stack radiator in the stack thermal management system of the fuel cell electric vehicle according to the embodiment of the present disclosure.

FIG. 7 is a view illustrating a state in which the first stack radiator is connected in parallel to the second stack radiator and the coolant is cooled by the first stack radiator and the second stack radiator in the stack thermal management system of the fuel cell electric vehicle according to the embodiment of the present disclosure.

### DETAILED DESCRIPTION

Hereinafter, some embodiments of the present disclosure will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of the embodiments of the present disclosure, a detailed description of related publicly-known configurations or functions will be omitted when it is determined that the detailed description obscures the understanding of the embodiments of the present disclosure.

In addition, the terms first, second, A, B, (a), and (b) may be used to describe constituent elements of the embodiments of the present disclosure. These terms are used only for the purpose of discriminating one constituent element from another constituent element, and the nature, the sequences, or the orders of the constituent elements are not limited by the terms. Further, unless otherwise defined, all terms used herein, including technical or scientific terms, have the same meaning as commonly understood by those skilled in the art to which the present disclosure pertains. The terms such as those defined in commonly used dictionaries should be interpreted as having meanings consistent with meanings in the context of related technologies and should not be interpreted as ideal or excessively formal meanings unless explicitly defined in the present application.

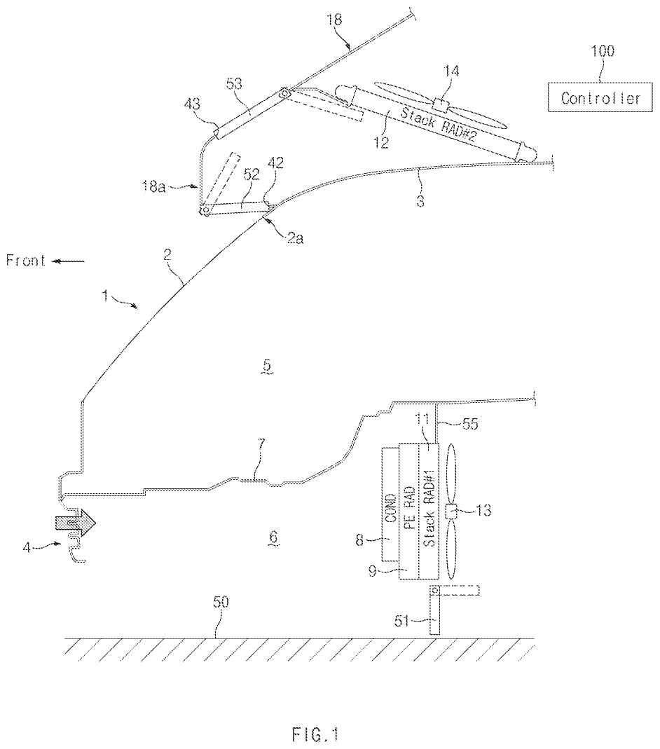

Referring to FIG. 1, a fuel cell electric vehicle 1 according to an embodiment of the present disclosure may include a cabin 5 disposed at a front side of a vehicle body, a front compartment 6 disposed below the cabin 5, and a wind deflector 18 disposed above the cabin 5.

The cabin 5 may include a windshield glass 2 provided at a front side of the cabin 5, a roof 3 provided at a top side of the cabin 5, and a cabin floor 7 provided at a bottom side of the cabin 5. The windshield glass 2 may be disposed to be inclined.

A power electronic (PE) system including an electric motor, a speed reducer, an inverter, and the like may be disposed in the front compartment 6. A plurality of heat exchangers such as a condenser 8 of an HVAC system, a radiator 9 of the PE system, and a first stack radiator 11 are disposed in the front compartment 6. The condenser 8 of the HVAC system, the radiator 9 of the PE system, and the first stack radiator 11 may be disposed rearward of the PE system. The condenser 8 of the HVAC system, the radiator 9 of the PE system, and the first stack radiator 11 may be disposed in a rear space of the front compartment 6. FIG. 1 illustrates that the condenser 8 of the HVAC system, the radiator 9 of the PE system, and the first stack radiator 11 are sequentially disposed in a longitudinal direction of the vehicle, but the present disclosure is not limited thereto. The arrangement order of the condenser 8 of the HVAC system, the radiator 9 of the PE system, and the first stack radiator 11 may be variously changed. The condenser 8 of the HVAC system, the radiator 9 of the PE system, and the first stack radiator 11 may each be an air-cooled heat exchanger that exchanges heat with outside air introduced into the front compartment 6. A first cooling fan 13 may be positioned rearward of the first stack radiator 11. The first cooling fan 13 may be configured to forcibly blow outside air toward the first stack radiator 11, the condenser 8 of the HVAC system, and the radiator 9 of the PE system. The first stack radiator 11 may be configured to exchange heat with the outside air to cool a coolant circulating through a coolant passageway of a fuel cell stack 21.

The fuel cell electric vehicle 1 may include a grille 4 provided at a front end of the front compartment 6. The grille 4 has a plurality of through-holes that allow outside air to flow to the front compartment 6. An opening area of the grille 4 of the fuel cell electric vehicle 1 may be relatively small. Therefore, a flow rate of outside air introduced into the front compartment 6 may be relatively low.

According to the embodiment of the present disclosure, a lower side of the front compartment 6 may be opened toward a road, and outside air may be introduced into the front compartment 6 through the opened lower side of the front compartment 6, which makes it possible to supplement the flow rate of outside air.

An upper partition wall 55 may be fixedly disposed on the first stack radiator 11. The upper partition wall 55 may extend vertically (in a height direction of the vehicle) from an upper end of the first stack radiator 11 toward the cabin floor 7. Therefore, the upper partition wall 55 may block a gap between the cabin floor 7 and the upper end of the first stack radiator 11. Since the upper partition wall 55 blocks the gap between the cabin floor 7 and the upper end of the first stack radiator 11 as described above, the outside air introduced into the front compartment 6 may forcibly pass through the condenser 8, the radiator 9, and the first stack radiator 11. Therefore, a contact area between the outside air and the first stack radiator 11 may relatively increase.

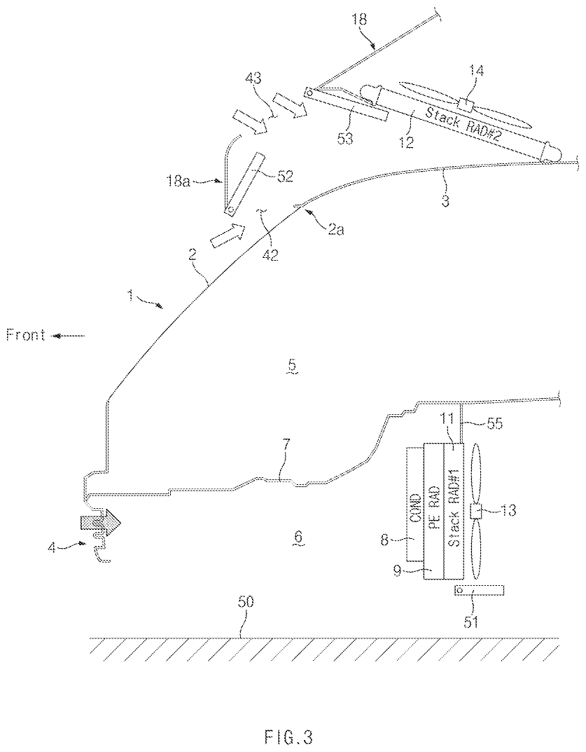

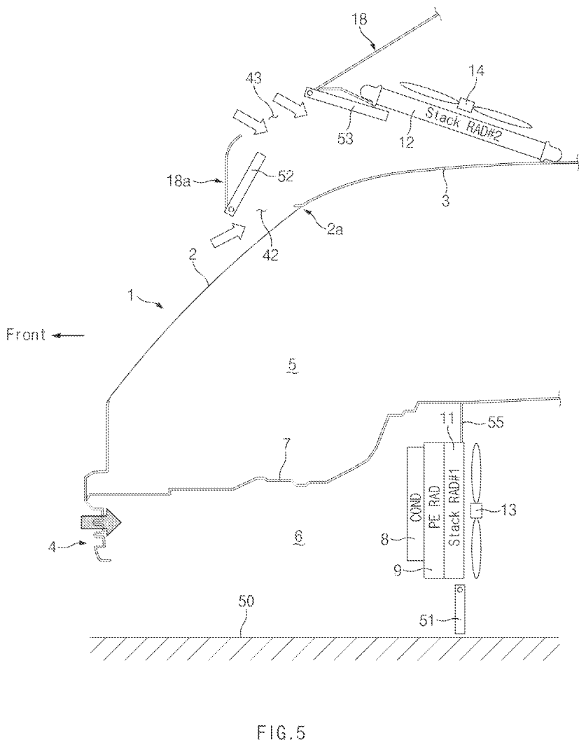

A movable member 51 may be movably disposed below the first stack radiator 11. The movable member 51 may move between a covered position (see FIGS. 1 and 5) at which the movable member 51 covers a gap between a ground surface 50 and a lower end of the first stack radiator 11 and an uncovered position (see FIG. 3) at which the movable member 51 uncovers the gap between the ground surface 50 and the lower end of the first stack radiator 11. When the movable member 51 is positioned at the covered position (see FIGS. 1 and 5), the outside air cannot pass through the gap between the ground surface 50 and the lower end of the first stack radiator 11. Therefore, a flow rate of the outside air passing through the condenser 8, the radiator 9, and the first stack radiator 11 may relatively increase. In particular, the contact area between the outside air and the first stack radiator 11 may relatively increase. When the movable member 51 is positioned at the uncovered position (see FIG. 3), the outside air may pass through the gap between the ground surface 50 and the lower end of the first stack radiator 11. Therefore, a flow rate of the outside air passing through the condenser 8, the radiator 9, and the first stack radiator 11 may relatively decrease. However, the flow of the outside air is not hindered by the movable member 51, such that aerodynamic performance of the fuel cell electric vehicle 1 may be improved. The movable member 51 may be configured to be moved by a drive mechanism including an actuator such as a motor.

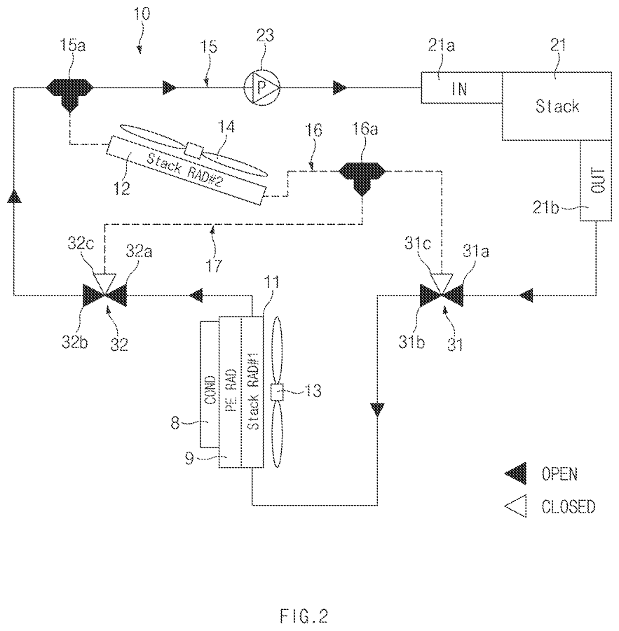

According to the embodiment, the movable member 51 may be mounted on a bottom structure of the vehicle body so as to be rotatable by means of a pivot pin. Therefore, the movable member 51 may rotate to a position aligned with an axis in the height direction of the vehicle, such that the movable member 51 may be positioned at the covered position (see FIGS. 1 and 5). Further, the movable member 51 may rotate to a position aligned with an axis in a longitudinal direction of the vehicle, such that the movable member 51 may be positioned at the uncovered position (see FIG. 2). A length of the movable member 51 may be determined so that a lower end of the movable member 51 does not come into direct contact with the ground surface when the movable member 51 is positioned at the covered position.

According to another embodiment, the movable member 51 may be configured to vertically slide toward the ground surface from the bottom structure of the vehicle body. When the movable member 51 slides from the lower end of the first stack radiator 11 toward the ground surface 50, the movable member 51 may be positioned at the covered position. When the movable member 51 slides from the lower end of the first stack radiator 11 toward the front compartment 6, the movable member 51 may be positioned at the uncovered position.

The wind deflector 18 may be attached onto the roof 3. The wind deflector 18 may have a streamlined shape to conform to the aerodynamic performance. An upper wall of the wind deflector 18 may be inclined upward from the front side of the vehicle toward the rear side of the vehicle. The wind deflector 18 may have a limited cavity therein.

A second stack radiator 12 may be provided in the cavity of the wind deflector 18. The second stack radiator 12 may be an air-cooled heat exchanger that exchanges heat with outside air introduced into the cavity of the wind deflector 18. A second cooling fan 14 may be positioned rearward of the second stack radiator 12. The second cooling fan 14 may be configured to forcibly blow outside air toward the second stack radiator 12. The second stack radiator 12 may be configured to exchange heat with the outside air to cool the coolant circulating through a coolant passageway of the fuel cell stack 21.

In particular, the second stack radiator 12 may be inclined in the cavity of the wind deflector 18. Therefore, a mounting space for the second stack radiator 12 may be sufficiently ensured, and thus a capacity (size) of the second stack radiator 12 may be larger than a capacity (size) of the first stack radiator 11.

A front portion of the wind deflector 18 may protrude toward the front side of the vehicle from an upper end of the windshield glass 2 so that a front end 18a of the wind deflector 18 is positioned forward of the upper end of the windshield glass 2. Since the front end 18a of the wind deflector 18 is positioned forward of the upper end of the windshield glass 2 as described above, the aerodynamic performance of the fuel cell electric vehicle 1 may be sufficiently ensured.

The wind deflector 18 may have a lower opening 42 provided at a front lower side of the wind deflector 18, and an upper opening 43 provided in an upper wall of the wind deflector 18. The lower opening 42 may be directed toward an upper side of the windshield glass 2. The upper opening 43 may be directed toward an upper space of the fuel cell electric vehicle 1. A lower flap 52 may be pivotably mounted in the lower opening 42. An upper flap 53 may be pivotably mounted in the upper opening 43. The lower flap 52 may be configured to move between a covered position (see FIG. 1) at which the lower flap 52 covers the lower opening 42 and an uncovered position (see FIGS. 3 and 5) at which the lower flap 52 uncovers the lower opening 42. The upper flap 53 may be configured to move between a covered position (see FIG. 1) at which the upper flap 53 covers the upper opening 43 and an uncovered position (see FIGS. 3 and 5) at which the upper flap 53 uncovers the upper opening 43. The lower flap 52 and the upper flap 53 may each be configured to be moved by a drive mechanism including an actuator such as a motor.

A controller 100 may include a processor and a memory. The processor may be programmed to receive control instructions stored in the memory and transmit the control instructions to an actuator for the movable member 51, an actuator for the lower flap 52, an actuator for the upper flap 53, an actuator for the first cooling fan 13, and an actuator for the second cooling fan 14. The memory may be a data storage such as a hard disc drive, a solid-state drive, a server, a volatile storage medium, or a non-volatile storage medium.

Specifically, the controller 100 may be configured to control the actuator for the movable member 51, the actuator for the lower flap 52, the actuator for the upper flap 53, the actuator for the first cooling fan 13, and the actuator for the second cooling fan 14 in accordance with a driving condition of the fuel cell electric vehicle and a load condition of the fuel cell stack 21. Therefore, a flow of outside air flowing into the front compartment 6, a flow of outside air flowing into the cavity of the wind deflector 18, and a flow rate of outside air may be adjusted, such that the performance in cooling the fuel cell stack 21 and the aerodynamic performance of the fuel cell electric vehicle 1 may be optimized.

Referring to FIG. 2, the fuel cell electric vehicle 1 may include the fuel cell stack 21, and a stack thermal management system 10 configured to manage a temperature of the fuel cell stack 21. The stack thermal management system 10 may include the first stack radiator 11 and the second stack radiator 12. The first stack radiator 11 may be thermally and fluidly connected to the fuel cell stack 21 through a coolant loop 15. A pump 23 configured to circulate the coolant may be fluidly connected to the coolant loop 15. The pump 23 may be disposed in the coolant loop 15 and provided at a point between an outlet of the first stack radiator 11 and an inlet 21a of the fuel cell stack 21. The second stack radiator 12 may be connected in parallel to the first stack radiator 11 through a distribution conduit 16. Therefore, the distribution conduit 16 may be configured to allow at least a portion of the coolant, which exits the fuel cell stack 21, to flow (be directed) to the second stack radiator 12. Specifically, the distribution conduit 16 may be connected to the coolant loop 15 and connect an upstream point of the fuel cell stack 21 and a downstream point of an outlet 21b of the fuel cell stack 21. An inlet of the distribution conduit 16 is connected to the downstream point of the fuel cell stack 21. Specifically, the inlet of the distribution conduit 16 may be connected to a point between the outlet 21b of the fuel cell stack 21 and an inlet of the first stack radiator 11. An outlet of the distribution conduit 16 is connected to the upstream point of the fuel cell stack 21. Specifically, the outlet of the distribution conduit 16 may be connected to a point 15a between an inlet of the pump 23 and the outlet of the first stack radiator 11. Since the second stack radiator 12 is fluidly connected to the distribution conduit 16, the second stack radiator 12 may be connected in parallel to the first stack radiator 11 through the distribution conduit 16, and the distribution conduit 16 may fluidly connect the second stack radiator 12 and the coolant loop 15.

A first switching valve 31 may be provided at a connection portion between the coolant loop 15 and the distribution conduit 16. The first switching valve 31 may be configured to adjust or control the flow of the coolant between the coolant loop 15 and the distribution conduit 16.

The first switching valve 31 may be configured to adjust the flow of the coolant between the outlet 21b of the fuel cell stack 21, the first stack radiator 11, and the second stack radiator 12. Specifically, the first switching valve 31 may include a first port 31a connected to the outlet 21b of the fuel cell stack 21, a second port 31b connected to the inlet of the first stack radiator 11, and a third port 31c connected to the distribution conduit 16. The first switching valve 31 may perform a switching operation so that the first port 31a selectively communicates with the second port 31b and/or the third port 31c.

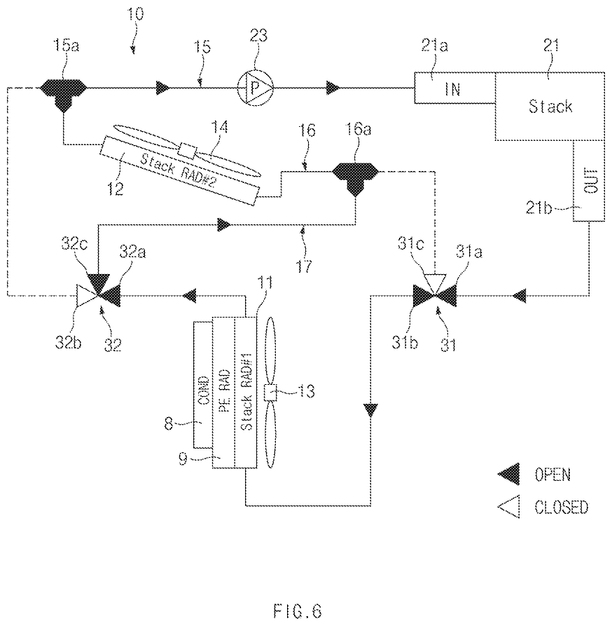

Referring to FIGS. 2 and 6, the first switching valve 31 may perform the switching operation to block the flow of the coolant to the distribution conduit 16 and allow the flow of the coolant to the first stack radiator 11. Specifically, the first port 31a and the second port 31b are opened, and the third port 31c is closed, such that the first port 31a communicates with the second port 31b, and the coolant exiting the outlet 21b of the fuel cell stack 21 may flow only to the first stack radiator 11 without flowing to the distribution conduit 16.

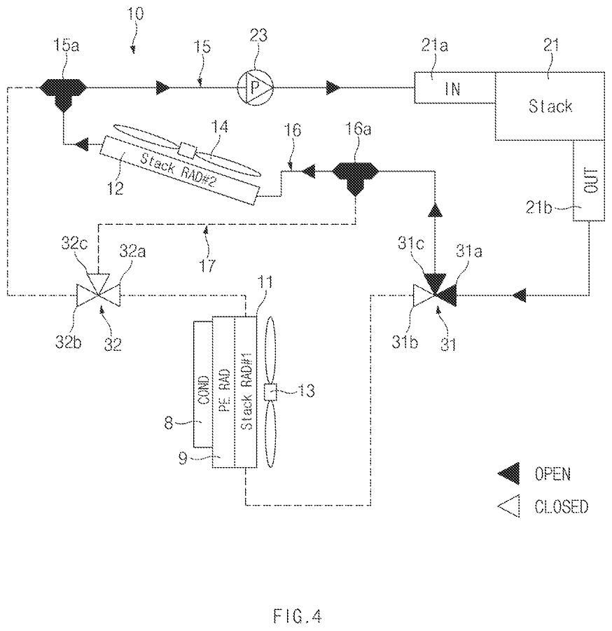

Referring to FIG. 4, the first switching valve 31 may perform the switching operation to allow the flow of the coolant to the distribution conduit 16 and block the flow of the coolant to the first stack radiator 11. Specifically, the first port 31a and the third port 31c are opened, and the second port 31b is closed, such that the first port 31a communicates with the third port 31c, and the coolant exiting the outlet 21b of the fuel cell stack 21 may flow to the second stack radiator 12 through the distribution conduit 16 without flowing to the first stack radiator 11.

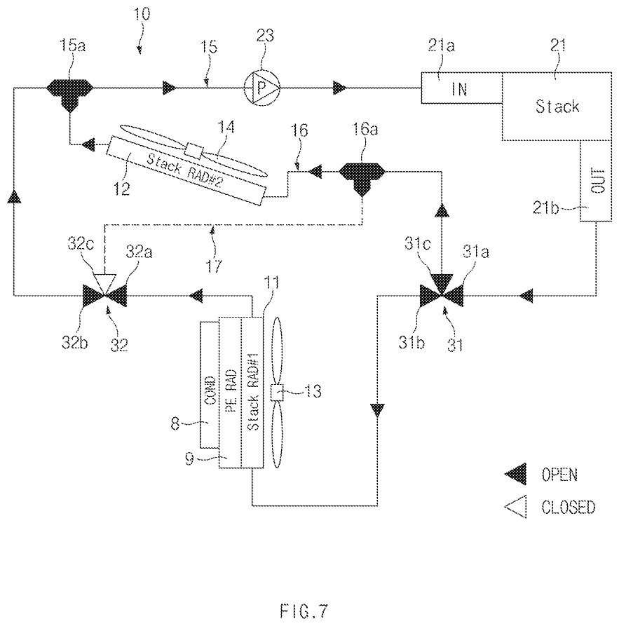

Referring to FIG. 7, the first switching valve 31 may perform the switching operation to allow the flow of the coolant to the distribution conduit 16 and allow the flow of the coolant to the first stack radiator 11. Specifically, the first port 31a, the second port 31b, and third port 31c are opened, such that the first port 31a communicates with the second port 31b and the third port 31c, and the coolant exiting the outlet 21b of the fuel cell stack 21 may flow to the first stack radiator 11 and the second stack radiator 12. That is, the coolant may be distributed to the first stack radiator 11 and the second stack radiator 12.

Referring to FIG. 2, a connection conduit 17 may be configured to fluidly connect the coolant loop 15 and the distribution conduit 16. The connection conduit 17 may be configured to allow the coolant exiting the first stack radiator 11 to flow (be directed) to the second stack radiator 12. That is, the connection conduit 17 may allow the coolant exiting the first stack radiator 11 to flow to the second stack radiator 12. Specifically, the connection conduit 17 may connect one side point of the distribution conduit 16 and a downstream point of the first stack radiator 11. An inlet of the connection conduit 17 may be disposed in the coolant loop 15 and connected between the pump 23 and the outlet of the first stack radiator 11. An outlet of the connection conduit 17 may be disposed in the distribution conduit 16 and connected to an upstream point 16a of the second stack radiator 12.

A second switching valve 32 may be provided at a connection portion between the coolant loop 15 and the connection conduit 17. The second switching valve 32 may be configured to adjust or control the flow of the coolant between the coolant loop 15 and the connection conduit 17. In particular, the second switching valve 32 may be configured to adjust the flow of the coolant between the first stack radiator 11 and the connection conduit 17. Specifically, the second switching valve 32 may include a first port 32a connected to the outlet of the first stack radiator 11, a second port 32b connected to the inlet of the pump 23, and a third port 32c connected to the connection conduit 17. The second switching valve 32 may perform a switching operation so that the first port 32a selectively communicates with the second port 32b and/or the third port 32c.

Referring to FIGS. 2 and 7, the second switching valve 32 may perform the switching operation to block the flow of the coolant to the connection conduit 17 and allow the flow of the coolant to the pump 23. Specifically, the first port 32a and the second port 32b are opened, and the third port 32c is closed, such that the first port 32a communicates with the second port 32b, and the coolant exiting the first stack radiator 11 may flow to the inlet of the pump 23 without flowing to the connection conduit 17. That is, the coolant exiting the first stack radiator 11 may be allowed to flow to the fuel cell stack 21 by the pump 23.

Referring to FIG. 4, the second switching valve 32 may perform the switching operation to block the flow of the coolant to the connection conduit 17 and block the flow of the coolant to the pump 23. Specifically, the first port 32a, the second port 32b, and the third port 32c are closed, such that the first port 32a, the second port 32b, and the third port 31c do not communicate with one another.

Referring to FIG. 6, the second switching valve 32 may perform the switching operation to allow the flow of the coolant to the connection conduit 17 and block the flow of the coolant to the pump 23. Specifically, the first port 32a and the third port 32c are opened, and the second port 32b is closed, such that the first port 32a communicates with the third port 32c, and the coolant exiting the first stack radiator 11 may flow to the second stack radiator 12 through the connection conduit 17 and the distribution conduit 16. That is, the first stack radiator 11 is connected in series to the second stack radiator 12, such that the coolant may flow to the second stack radiator 12 from the fuel cell stack 21 through the first stack radiator 11.

The controller 100 may directly control the operation of the first cooling fan 13, the operation of the second cooling fan 14, the operation of the first switching valve 31, the operation of the second switching valve 32, and the operation of the pump 23 or use a stack controller (not illustrated) to indirectly control the operation of the first cooling fan 13, the operation of the second cooling fan 14, the operation of the first switching valve 31, the operation of the second switching valve 32, and the operation of the pump 23.

In the fuel cell electric vehicle 1 according to the embodiment of the present disclosure, the operation of the movable member 51, the operation of the lower flap 52, the operation of the upper flap 53, the operation of the first cooling fan 13, the operation of the second cooling fan 14, the operation of the first switching valve 31, and the operation of the second switching valve 32 may be appropriately controlled by the controller 100 in accordance with the driving condition of the fuel cell electric vehicle 1 and the load condition of the fuel cell stack 21. Therefore, the performance in cooling the fuel cell stack 21 and the aerodynamic performance of the fuel cell electric vehicle 1 may be optimized in accordance with the driving condition of the fuel cell electric vehicle 1.

The driving condition of the fuel cell electric vehicle 1 may be divided into a low-speed driving condition in which the speed of the fuel cell electric vehicle 1 is equal to or lower than a preset speed and a high-speed driving condition in which the speed of the fuel cell electric vehicle 1 is higher than the preset speed. The load condition of the fuel cell stack 21 may be divided into a low-load condition in which the cooling load of the fuel cell stack 21 is equal to or lower than a preset load and a high-load condition in which the cooling load of the fuel cell stack 21 is higher than the preset load.

Referring to FIG. 1, when the fuel cell stack 21 operates in the low-load condition and the fuel cell electric vehicle 1 travels in the low-speed driving condition, the controller 100 may move the movable member 51 to the covered position, move the lower flap 52 to the covered position, and move the upper flap 53 to the covered position. When the movable member 51 is positioned at the covered position, the outside air may forcibly pass through the condenser 8, the radiator 9, and the first stack radiator 11 by means of the upper partition wall 55 and the movable member 51. Further, as the first cooling fan 13 operates, the first stack radiator 11 may exchange heat with the outside air introduced through the grille 4, such that the coolant exiting the fuel cell stack 21 may be cooled to an appropriate temperature. The flow rate of the outside air introduced into the front compartment 6 through the grille 4 is relatively low in the low-speed driving condition, such that the aerodynamic performance of the fuel cell electric vehicle 1 may be ensured even though the movable member 51 is positioned at the covered position. The heat generating amount of the fuel cell stack 21 is relatively small in the low-load condition of the fuel cell stack 21, such that the coolant may be sufficiently cooled only by the first stack radiator 11.

Referring to FIG. 2, when the fuel cell stack 21 operates in the low-load condition and the fuel cell electric vehicle 1 travels in the low-speed driving condition, the controller 100 may allow the first switching valve 31 to perform the switching operation to block the flow of the coolant to the distribution conduit 16 and allow the flow of the coolant to the first stack radiator 11. The first port 31a and the second port 31b are opened, and the third port 31c is closed, such that the first port 31a communicates with the second port 31b, and the coolant exiting the outlet 21b of the fuel cell stack 21 may flow only to the first stack radiator 11 without flowing to the distribution conduit 16 and the second stack radiator 12. The controller 100 may allow the second switching valve to perform the switching operation to block the flow of the coolant to the connection conduit 17 and allow the flow of the coolant to the pump 23. The first port 32a and the second port 32b are opened, and the third port 32c is closed, such that the first port 32a communicates with the second port 32b, and the coolant exiting the first stack radiator 11 may flow to the inlet of the pump 23 without flowing to the connection conduit 17. That is, the coolant exiting the first stack radiator 11 may be allowed to flow to the fuel cell stack 21 by the pump 23. As described above, when the fuel cell electric vehicle 1 operates in the low-speed low-load operating condition, the coolant is circulated through the fuel cell stack 21 and the first stack radiator 11 by the pump 23 in the stack thermal management system 10, such that the performance in cooling the fuel cell stack 21 may be ensured.

Referring to FIG. 3, when the fuel cell stack 21 operates in the low-load condition and the fuel cell electric vehicle 1 travels in the high-speed driving condition, the controller 100 may move the movable member 51 to the uncovered position, move the lower flap 52 to the uncovered position, and move the upper flap 53 to the uncovered position. When the fuel cell electric vehicle 1 travels at high speed, a flow rate of outside air introduced into the front compartment 6 through the grille 4 may relatively increase. Therefore, when the movable member 51 is positioned at the covered position, the movable member 51 may hinder the flow of the outside air, which may relatively cause deterioration in the aerodynamic performance. Therefore, it is possible to prevent the deterioration in aerodynamic performance as the movable member 51 is positioned at the uncovered position. Further, since the aerodynamic performance at the upper side of the fuel cell electric vehicle 1 is basically ensured by the wind deflector 18, the aerodynamic performance does not deteriorate even though the lower flap 52 and the upper flap 53 are positioned at the uncovered positions.

Referring to FIG. 4, when the fuel cell stack 21 operates in the low-load condition and the fuel cell electric vehicle 1 travels in the high-speed driving condition, the controller 100 may allow the first switching valve 31 to perform the switching operation to allow the flow of the coolant to the distribution conduit 16 and block the flow of the coolant to the first stack radiator 11. The first port 31a and the third port 31c are opened, and the second port 31b is closed, such that the first port 31a communicates with the third port 31c, and the coolant exiting the outlet 21b of the fuel cell stack 21 may flow to the second stack radiator 12 through the distribution conduit 16 without flowing to the first stack radiator 11. The controller 100 may allow the second switching valve 32 to perform the switching operation to block the flow of the coolant to the connection conduit 17 and block the flow of the coolant to the pump 23. The first port 32a, the second port 32b, and the third port 32c are closed, such that the first port 32a, the second port 32b, and the third port 31c do not communicate with one another. As described above, when the fuel cell electric vehicle 1 operates in the high-speed low-load operating condition, the second cooling fan 14 operates and the coolant is circulated through the fuel cell stack 21 and the second stack radiator 12 by the pump 23 in the stack thermal management system 10, such that the performance in cooling the fuel cell stack 21 may be ensured.

Referring to FIG. 5, when the fuel cell stack 21 operates in the high-load condition and the fuel cell electric vehicle 1 travels in the low-speed driving condition, the controller 100 may move the movable member 51 to the covered position, move the lower flap 52 to the uncovered position, and move the upper flap 53 to the uncovered position. When the movable member 51 is positioned at the covered position, the outside air may forcibly pass through the condenser 8, the radiator 9, and the first stack radiator 11 by means of the upper partition wall 55 and the movable member 51, the first cooling fan 13 may operate, and the first stack radiator 11 may exchange heat with the outside air introduced through the grille 4, such that the coolant exiting the fuel cell stack 21 may be cooled to an appropriate temperature. The flow rate of the outside air introduced into the front compartment 6 through the grille 4 is relatively low in the low-speed driving condition, such that the aerodynamic performance of the fuel cell electric vehicle 1 may be ensured even though the movable member 51 is positioned at the covered position. The heat generating amount of the fuel cell stack 21 is relatively large in the high-load driving condition. Therefore, the lower flap 52 and the upper flap 53 are positioned at the uncovered positions, and the second cooling fan 14 operates, such that the coolant may be cooled to an appropriate temperature by the first stack radiator 11 and the second stack radiator 12.

Referring to FIG. 6, when the fuel cell stack 21 operates in the high-load condition and the fuel cell electric vehicle 1 travels in the low-speed driving condition, the controller 100 may allow the first switching valve 31 to perform the switching operation to block the flow of the coolant to the distribution conduit 16 and allow the flow of the coolant to the first stack radiator 11. The first port 31a and the second port 31b are opened, and the third port 31c is closed, such that the first port 31a communicates with the second port 31b, and the coolant exiting the outlet 21b of the fuel cell stack 21 may flow only to the first stack radiator 11 without flowing to the distribution conduit 16. Further, the controller 100 may allow the second switching valve 32 to perform the switching operation to allow the flow of the coolant to the connection conduit 17 and block the flow of the coolant to the pump 23. The first port 32a and the third port 32c are opened, and the second port 32b is closed, such that the first port 32a communicates with the third port 32c, and the coolant exiting the first stack radiator 11 may flow to the second stack radiator 12 through the connection conduit 17 and the distribution conduit 16. That is, the first stack radiator 11 is connected in series to the second stack radiator 12, such that the coolant may flow to the second stack radiator 12 from the fuel cell stack 21 through the first stack radiator 11. As described above, when the fuel cell electric vehicle 1 operates in the low-speed high-load operating condition, the first cooling fan 13 and the second cooling fan 14 operate and the coolant is circulated through the fuel cell stack 21, the first stack radiator 11, and the second stack radiator 12 by the pump 23 in the stack thermal management system 10, such that the performance in cooling the fuel cell stack 21 may be ensured.

Referring to FIG. 5, when the fuel cell stack 21 operates in the high-load condition and the fuel cell electric vehicle 1 travels in the high-speed driving condition, the controller 100 may move the movable member 51 to the covered position, move the lower flap 52 to the uncovered position, and move the upper flap 53 to the uncovered position. When the movable member 51 is positioned at the covered position, the outside air may forcibly pass through the condenser 8, the radiator 9, and the first stack radiator 11 by means of the upper partition wall 55 and the movable member 51, the first cooling fan 13 may operate, and the first stack radiator 11 may exchange heat with the outside air introduced through the grille 4, such that the coolant exiting the fuel cell stack 21 may be cooled to an appropriate temperature. The flow rate of the outside air introduced into the front compartment 6 through the grille 4 is relatively high in the high-speed driving condition, such that the aerodynamic performance of the fuel cell electric vehicle 1 may relatively deteriorate when the movable member 51 is positioned at the covered position. However, the heat generating amount of the fuel cell stack 21 is relatively large in the high-load driving condition. Therefore, the lower flap 52 and the upper flap 53 are positioned at the uncovered positions, and the second cooling fan 14 operates, such that the coolant may be cooled to an appropriate temperature by the first stack radiator 11 and the second stack radiator 12. As an alternative example, the movable member 51 may move to the uncovered position to prevent the deterioration in aerodynamic performance when the fuel cell electric vehicle 1 travels in the high-speed high-load condition.

Referring to FIG. 7, when the fuel cell stack 21 operates in the high-load condition and the fuel cell electric vehicle 1 travels in the high-speed driving condition, the controller 100 may allow the first switching valve 31 to perform the switching operation to allow the flow of the coolant to the distribution conduit 16 and the flow of the coolant to the first stack radiator 11. The first port 31a, the second port 31b, and third port 31c are opened, such that the first port 31a communicates with the second port 31b and the third port 31c, and the coolant exiting the outlet 21b of the fuel cell stack 21 may flow to the first stack radiator 11 and the second stack radiator 12. The controller 100 may allow the second switching valve 32 to perform the switching operation to block the flow of the coolant to the connection conduit 17 and allow the flow of the coolant to the pump 23. The first port 32a and the second port 32b are opened, and the third port 32c is closed, such that the first port 32a communicates with the second port 32b, and the coolant exiting the first stack radiator 11 may flow to the inlet of the pump 23 without flowing to the connection conduit 17. As described above, when the fuel cell electric vehicle 1 operates in the high-speed high-load operating condition, the first cooling fan 13 and the second cooling fan 14 operate in the stack thermal management system 10, and the first stack radiator 11 and the second stack radiator 12 are connected in parallel to the fuel cell stack 21 and the pump 23. Therefore, the coolant may be distributed to the first stack radiator 11 and the second stack radiator 12, and the coolant is circulated through the fuel cell stack 21, the first stack radiator 11, and the second stack radiator 12 by the pump 23, such that the performance in cooling the fuel cell stack 21 may be ensured.

The above description is simply given for illustratively describing the technical spirit of the present disclosure, and those skilled in the art to which the present disclosure pertains will appreciate that various changes and modifications are possible without departing from the essential characteristic of the present disclosure.

Therefore, the embodiments disclosed in the present disclosure are provided for illustrative purposes only but not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

1. A fuel cell electric vehicle comprising:
a cabin;
a front compartment positioned below the cabin;
a wind deflector positioned above the cabin; and
a stack thermal management system including first and second stack radiators each thermally connected to a fuel cell stack.

2. The fuel cell electric vehicle of claim 1, further comprising:
an upper partition wall configured to block a gap between the first stack radiator and a cabin floor of the cabin; and
a movable member movably disposed below the first stack radiator.

3. The fuel cell electric vehicle of claim 2, wherein the movable member is configured to move between a covered position at which the movable member covers a gap between a ground surface and a lower end of the first stack radiator, and an uncovered position at which the movable member uncovers the gap between the ground surface and the lower end of the first stack radiator.

4. The fuel cell electric vehicle of claim 1, wherein the wind deflector comprises:
an opening; and
a flap configured to cover or uncover the opening.

5. The fuel cell electric vehicle of claim 1, wherein a front end of the wind deflector is positioned forward of an upper end of a windshield glass of the cabin.

6. The fuel cell electric vehicle of claim 1, wherein the second stack radiator is inclined within the wind deflector.

7. The fuel cell electric vehicle of claim 1, wherein the first stack radiator is thermally connected to the fuel cell stack through a coolant loop, and the second stack radiator is connected in parallel to the first stack radiator through a distribution conduit.

8. The fuel cell electric vehicle of claim 7, wherein the stack thermal management system further comprises a first switching valve provided at a connection portion between the distribution conduit and the coolant loop, and the first switching valve is configured to adjust a flow of a coolant between the coolant loop and the distribution conduit.

9. The fuel cell electric vehicle of claim 8, wherein the first switching valve is configured to adjust a flow of the coolant between the second stack radiator, the first stack radiator, and an outlet of the fuel cell stack.

10. The fuel cell electric vehicle of claim 8, wherein the first switching valve is configured to block or allow a flow of the coolant to the distribution conduit, and to block or allow a flow of the coolant to the first stack radiator.

11. The fuel cell electric vehicle of claim 7, wherein the stack thermal management system further comprises a connection conduit configured to connect the coolant loop and the distribution conduit.

12. The fuel cell electric vehicle of claim 11, wherein the connection conduit is configured to allow the coolant exiting the first stack radiator to flow to the second stack radiator.

13. The fuel cell electric vehicle of claim 11, wherein the stack thermal management system further comprises a second switching valve provided at a connection portion between the connection conduit and the coolant loop, and the second switching valve is configured to adjust a flow of the coolant between the coolant loop and the connection conduit.

14. The fuel cell electric vehicle of claim 13, wherein the second switching valve is configured to adjust a flow of the coolant between the first stack radiator and the connection conduit.

15. The fuel cell electric vehicle of claim 13, wherein the second switching valve is configured to block or allow a flow of the coolant to the connection conduit.

16. The fuel cell electric vehicle of claim 1, further comprising:
a coolant loop configured to connect the fuel cell stack and the first stack radiator;
a distribution conduit configured to connect the second stack radiator and the coolant loop;
a connection conduit configured to connect the coolant loop and the distribution conduit;
a first switching valve configured to adjust a flow of a coolant between the coolant loop and the distribution conduit;
a second switching valve configured to adjust a flow of the coolant between the coolant loop and the connection conduit; and
a controller configured to control an operation of the first switching valve and an operation of the second switching valve in accordance with a driving condition and a load condition of the fuel cell stack.

17. The fuel cell electric vehicle of claim 16, wherein when the fuel cell stack operates in a low-load condition in which a cooling load of the fuel cell stack is equal to or lower than a preset load and the fuel cell electric vehicle travels in a low-speed driving condition in which a speed of the fuel cell electric vehicle is equal to or lower than a preset speed, the controller controls the first switching valve to block a flow of the coolant to the distribution conduit and allow a flow of the coolant to the first stack radiator, and the controller controls the second switching valve to block a flow of the coolant to the connection conduit.

18. The fuel cell electric vehicle of claim 16, wherein when the fuel cell stack operates in a low-load condition in which a cooling load of the fuel cell stack is equal to or lower than a preset load and the fuel cell electric vehicle travels in a high-speed driving condition in which a speed of the fuel cell electric vehicle is higher than a preset speed, the controller controls the first switching valve to allow a flow of the coolant to the distribution conduit and block a flow of the coolant to the first stack radiator, and the controller controls the second switching valve to block a flow of the coolant to the connection conduit.

19. The fuel cell electric vehicle of claim 16, wherein when the fuel cell stack operates in a high-load condition in which a cooling load of the fuel cell stack is higher than a preset load and the fuel cell electric vehicle travels in a low-speed driving condition in which a speed of the fuel cell electric vehicle is equal to or lower than a preset speed, the controller controls the first switching valve to block a flow of the coolant to the distribution conduit and allow a flow of the coolant to the first stack radiator, and the controller controls the second switching valve to allow a flow of the coolant to the connection conduit.

20. The fuel cell electric vehicle of claim 16, wherein when the fuel cell stack operates in a high-load condition in which a cooling load of the fuel cell stack is higher than a preset load and the fuel cell electric vehicle travels in a high-speed driving condition in which a speed of the fuel cell electric vehicle is higher than a preset speed, the controller controls the first switching valve to allow a flow of the coolant to the distribution conduit and a flow of the coolant to the first stack radiator, and the controller controls the second switching valve to block a flow of the coolant to the connection conduit.
